(19) United States
(12) Patent Application Publication
(10) Pub. No.: US 2023/0401583 A1
(43) Pub. Date: Dec. 14, 2023

(54) METHOD TO DETECT AND OBSTRUCT FRAUDULENT TRANSACTIONS

(71) Applicant: International Business Machines Corporation, Armonk, NY (US)

(72) Inventors: Doga Tav, Fredericton (CA); Cesar Augusto Rodriguez Bravo, Alajuela (CR)

(21) Appl. No.: 17/835,999

(22) Filed: Jun. 9, 2022

(51) Int. Cl. G06Q 20/40; G06Q 20/32; H04L 9/40

(52) U.S. Cl. CPC G06Q 20/4016; G06Q 20/407; G06Q 20/4012; G06Q 20/3278; H04L 63/1458

(57) ABSTRACT

A computer-implemented method for detecting and obstructing skimmer devices is disclosed. The computer-implemented method includes monitoring wireless communications within a network environment. The computer-implemented method further includes identifying information associated with one or more wireless communications within the network environment transmitted by an unknown wireless device. The computer-implemented method further includes selecting an obstruction rule based, at least in part, on the information associated with the one or more wireless communications transmitted by the unknown wireless device. The computer-implemented method further includes executing an obstruction action corresponding to the selected obstruction rule.

### BACKGROUND

The present invention relates generally to the field of transactions, and more particularly to, detecting and preventing fraudulent transactions.

A transaction involves a request for and an exchange of or access to an asset. For example, a transaction may involve a request for money at an automatic teller machine (ATM) or purchasing goods at a store. A payment terminal, also known as a point of sale (POS) terminal or credit card terminal is a device which interfaces with payment cards to make electronic fund transfers. A terminal typically consists of a secure keypad (e.g., PIN pad) for entering a personal identification number (PIN), a screen, a means of capturing information from payments cards and a network connection to access the payment network for authorization. A payment terminal allows a merchant to capture required payment card (e.g., credit or debit card) information and to transmit this data to the merchant services provider or bank for authorization and finally, to transfer funds to the merchant. The terminal allows the merchant or their client to swipe, insert or hold a card near the device to capture the information. They are often connected to point of sale systems so that payment amounts and confirmation of payment can be transferred automatically to the merchants retail management system. A majority of card terminals transmit data over cellular connections, Wi-Fi, Bluetooth, or Near Field Communication (NFC).

### SUMMARY

According to one embodiment of the present invention, a computer-implemented method for detecting and obstructing skimmer devices is disclosed. The computer-implemented method includes monitoring wireless communications within a network environment. The computer-implemented method further includes identifying information associated with one or more wireless communications within the network environment transmitted by an unknown wireless device. The computer-implemented method further includes selecting an obstruction rule based, at least in part, on the information associated with the one or more wireless communications transmitted by the unknown wireless device. The computer-implemented method further includes executing an obstruction action corresponding to the selected obstruction rule.

According to another embodiment of the present invention, a computer program product for detecting and obstructing skimmer devices is disclosed. The computer program product includes one or more computer readable storage media and program instructions stored on the one or more computer readable storage media. The program instructions include instructions to monitor wireless communications within a network environment. The program instructions further include instructions to identify information associated with one or more wireless communications within the network environment transmitted by an unknown wireless device. The program instructions further include instructions to select an obstruction rule based, at least in part, on the information associated with the one or more wireless communications transmitted by the unknown wireless device. The program instructions further include instructions to execute an obstruction action corresponding to the selected obstruction rule.

According to another embodiment of the present invention, a computer system for detecting and obstructing skimmer devices is disclosed. The computer system includes one or more computer processors, one or more computer readable storage media, and computer program instructions, the computer program instructions being stored on the one or more computer readable storage media for execution by the one or more computer processors. The program instructions include instructions to monitor wireless communications within a network environment. The program instructions further include instructions to identify information associated with one or more wireless communications within the network environment transmitted by an unknown wireless device. The program instructions further include instructions to select an obstruction rule based, at least in part, on the information associated with the one or more wireless communications transmitted by the unknown wireless device. The program instructions further include instructions to execute an obstruction action corresponding to the selected obstruction rule.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a network computing environment for transaction obstruction program 101, generally designated 100, in accordance with at least one embodiment of the present invention.

FIG. 2 is a flow chart diagram depicting operational steps for transaction obstruction program 101, generally designated 200, in accordance with at least one embodiment of the present invention.

FIG. 3 is a flow chart diagram depicting operational steps for transaction obstruction program 101, generally designated 300, in accordance with at least one embodiment of the present invention.

FIG. 4 is a block diagram depicting components of a computer, generally designated 400, suitable for executing a transaction obstruction program 101 in accordance with at least one embodiment of the present invention.

FIG. 5 is a block diagram depicting a cloud computing environment 50 in accordance with at least one embodiment of the present invention.

FIG. 6 is block diagram depicting a set of functional abstraction model layers provided by cloud computing environment 50 depicted in FIG. 5 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of transactions, and more particularly to, detecting and preventing fraudulent transactions.

Many transactions are done wirelessly via Wi-Fi, Bluetooth, and Near Field Communication (NFC). Wireless skimmer devices can retrieve transaction data and transmit the transaction data to a party that is not supposed to receive the transaction information. Transaction data can include information associated with the magnetic strip of the card, credit card number, expiration date, and security code. Typically, wireless skimmers transmit transaction data without knowledge to the card holder and the transaction is completed as normal. Sometimes, a sticker is placed on transaction devices, and if ripped, torn, or removed, the sticker serves as indication that transaction device has been accessed or tampered with. For example, a torn sticker may be indicative of the possibility that an unauthorized device was connected to the transaction device. However, this does not prevent a skimmer device from being used and relies on consistent physical inspection to notice such a broken sticker. Further, many skimmer devices can operate outside of the transaction device and do not need to be placed physically inside the transaction device.

Embodiments of the present invention detect potential skimmer devices and take action such as blocking or jamming the potential skimmer device. Embodiments of the present invention detect potential skimmer devices wirelessly connected to a transaction device. Embodiments of the present invention identify a potential skimmer device based on a predetermined range of a transaction device to determine the average amount of connections, length of transactions, or patterns of connections. Based on identifying a potential skimmer device connection, embodiments of the present invention take action to further identify or stop the connection to protect the transaction information from being accessed or sent to an unauthorized device or party.

In some embodiments, based on identifying a wireless connection between a potential skimmer device and a transaction device, a man-in-the-middle (MITM) attack is launched. A MITM attack typically includes, the middle participant manipulates the information unknown to either of the two legitimate participants, acting to retrieve confidential information and otherwise cause damage.

Embodiments of the present invention monitor network communications between devices within a predetermined range of a transaction device to determine the nature and the intention of the parties. Embodiments of the present invention monitor wireless communications within a predetermine range of a transaction device to determine the average amount of connections, length of transactions, and other transaction information associated with the transaction device. Embodiments of the present invention identify malicious wireless communications based on a change in the number of connections, length of connections, random or strange connection patterns, etc. that are typical for the particular transaction devices or networks utilized by particular transaction devices. Embodiments of the present invention identify one or more nodes connected to a potential malicious connection. Embodiments of the present invention take action to stop a node from communicating with other devices by interfering with the communication or via utilizing pineapple capabilities. Embodiments of the present invention imitate the destination device or transaction device to either gather more information about what the source device, or skimmer device, is trying to do or information it is trying to collect. Embodiments of the present invention fool the device of interest or device trying to connect to it via multiple virtual devices similar to DDoS (Distributed Denial of Service) attack. DDoS is a category of malicious cyber-attacks that hackers or cybercriminals employ in order to make an online service, network resource or host machine unavailable to its intended users on the Internet.

Furthermore, embodiments of the present invention have a predefined set of rules to watch but more importantly, the system will allow customization and/or creating new rules for flexibility as per the specifics of the user deployment, such as via user input. Embodiments of the present invention can act as a virtual faraday cage which blocks the wireless communication by jamming every detected ID around it.

Embodiments of the present invention recognize the name of a device can be changed, making it harder to detect an unknown and possible fraudulent connection. Embodiments of the present invention monitor network connections and communications (e.g., user input, length of the connection and/or communication, threshold of connections and/or communication, duration of connection and/or communication, and information obtained) to determine if a connection and/or communication is possibly fraudulent. Embodiments of the present invention recognize blocking every wireless connection and/or communication is harmful since some wireless connections and/or communications during transactions are desired in order to approve and carryout a transaction. Embodiments of the present invention selectively block the identified potential skimmer device. For example, an identified potential skimmer device is identified based on how many other devices the potential skimmer device is connected to or the number of devices that are connected to the same network as a transaction device. Based on the number of devices connected, the identified potential skimmer device is blocked in order to not interfere with the desired connections in the network. For example, embodiments of the present invention block the connection between the potential skimmer device and the network while other allowable connections to the network stay connected. Embodiments of the present invention further recognize it is useful to collect or gather information on the potential skimmer device. Embodiments of the present invention further provides an active defense against potential skimmer devices based on the user's configuration settings.

According to embodiments of the present invention, a computer-implemented method, computer program product, and computer system for detecting and selectively blocking wireless skimmer device is disclosed. In an embodiment, a transaction obstruction program 101 actively monitors wireless communications within a predetermined area. In an embodiment, monitoring wireless communications further includes monitoring wireless network connections and wireless network connection attempts. While actively monitoring wireless communications within the predetermined area, transaction obstruction program 101 determines, based on a predetermined set of configurable rules, whether a wireless communication is associated with a potential skimmer device. Responsive to determining that the wireless communication is associated with a potential skimmer device, transaction obstruction program 101 determines, based on a second predetermined set of configurable rules, whether the potential skimmer device is malicious. For example, the potential skimmer device is determined to be malicious based, at least in part, on one or more of: determining that the potential skimmer device attempted or is currently attempting to identify a node which actively connects to other nodes, a number of successful connections of the potential skimmer device with other nodes in a given time period exceeds a first predetermined threshold, and an amount of time that the potential skimmer device remains connected or is in communication with another node exceeds a second predetermined threshold.

Responsive to determining that the potential skimmer device is in fact a malicious device, transaction obstruction program 101 executes at least one action from a predetermined set of configurable actions to stop, mislead, or otherwise deter the malicious skimmer device from communicating with other devices. For example, transaction obstruction program 101 may gather further information about communications made between the malicious skimmer device and other nodes by imitating a destination node or type of destination node from which the malicious skimmer device is trying to connect to. In another example, transaction obstruction program 101 may connect to the destination device via multiple virtual devices in a denial-of-service attack. Further responsive to determining that the potential skimmer device is a malicious device, transaction obstruction program 101 may alert a predetermined user of the malicious skimmer device and transmit or store details about the action performed to thwart the malicious skimmer device for use in decision making processes associated with future detected potential malicious skimmer devices.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

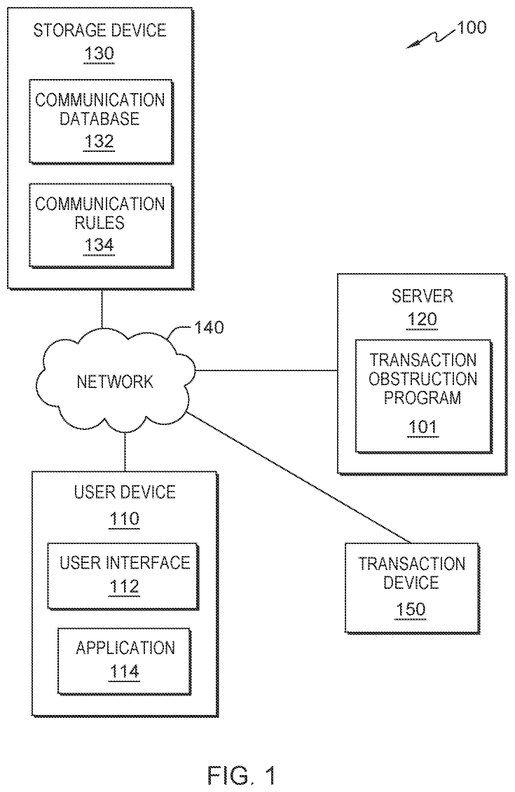

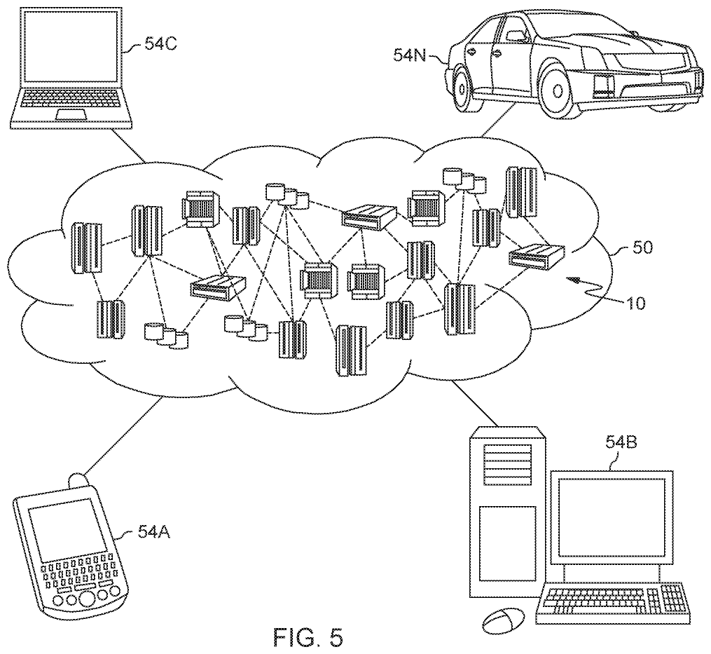

The present invention will now be described in detail with reference to the Figures. FIG. 1 is a functional block diagram of a network computing environment for transaction obstruction program 101, generally designated 100, in accordance with at least one embodiment of the present invention. In an embodiment, network computing environment 100 may be provided by cloud computing environment 50, as depicted and described with reference to FIG. 5, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

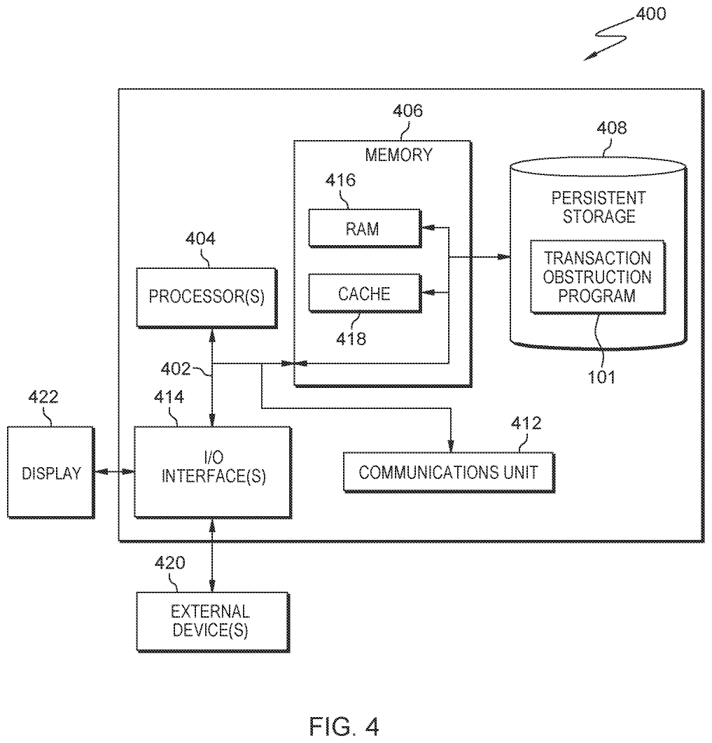

Network computing environment 100 includes user device 110, server 120, storage device 130, and transaction device 150, interconnected over network 140. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130, transaction device 150, and other devices (not depicted) via a network, such as network 140. User device 110 can include internal and external hardware components, as depicted and described in further detail with respect to FIG. 4.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on user device 110. In an embodiment, application 114 is representative of one or more applications (e.g., banking applications, consumer applications, social media applications, and email applications) located on user device 110. In various example embodiments, application 114 can be an application that a user of user device 110 utilizes to request or make a transaction. For example, a user utilizes a banking application to make a transaction to pay for gas at a gas station. In an embodiment, application 114 can be a client-side application associated with a server-side application running on server 120 (e.g., a client-side application associated with transaction obstruction program 101). In an embodiment, application 114 can operate to perform processing steps of transaction obstruction program 101 (i.e., application 114 can be representative of transaction obstruction program 101 operating on user device 110).

Server 120 is configured to provide resources to various computing devices, such as user device 110. For example, server 120 may host various resources, such as transaction obstruction program 101 that are accessed and utilized by a plurality of devices within network 140. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, transaction device 150, and other computing devices (not shown) within network computing environment 100 via a network, such as network 140.

Server 120 may include components as depicted and described in detail with respect to cloud computing node 10, as described in reference to FIG. 5 in accordance with at least one embodiment of the present invention. Server 120 may include components, as depicted and described in detail with respect to computing device 400 of FIG. 4, in accordance with at least one embodiment of the present invention.

Storage device 130 is a secure data repository for persistently storing communication database 132 and communication rules 134 utilized by various applications and user devices of a user, such as user device 110. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

In an embodiment, transaction obstruction program 101 may be configured to access various data sources, such as communication database 132 and communication rules 134, that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, transaction obstruction program 101 enables the authorized and secure processing of personal data. In an embodiment, transaction obstruction program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, transaction obstruction program 101 provides information regarding personal data and the nature (e.g., type, scope, purpose, duration, etc.) of the processing. In an embodiment, transaction obstruction program 101 provides a user with copies of stored personal data. In an embodiment, transaction obstruction program 101 allows for the correction or completion of incorrect or incomplete personal data. In an embodiment, transaction obstruction program 101 allows for the immediate deletion of personal data.

In an embodiment, communication database 132 includes various transaction information associated with a particular wireless network and/or transaction device. In an embodiment, communication database 132 includes various transaction data that may be associated with a user such as PIN, account number, credit card number, security question information, transaction history, or other transaction data. For example, communication database 132 includes information on the number of transactions, duration of transactions, types of transactions, information about the wireless connections between external devices and transaction devices via certain wireless networks, number of attempted connections to a network, number of simultaneous connections to the network. For example, communication database 132 stores information on the time, length of connection, device ID, and device configurations for a wireless connection at gas station A. In an embodiment, transaction obstruction program 101 accesses communication database 132 to retrieve information on connections, such as the number of transaction, duration of transactions, types of transactions, number of attempted connections to a network, number of simultaneous connections to the network, information about the wireless connections between external devices and transaction devices via certain wireless networks, previously connected or allowed device IDs. For example, if a device is identified as a desired or allowed connection, the device ID of this device is stored and accessed in communication database 132.

In an embodiment, communication database 132 includes information on the priority level of a wireless connection. In an embodiment, a priority level is the level of certainty transaction obstruction program 101 determines a connection or device to be malicious. For example, a higher priority level indicates transaction obstruction program 101 is more certain a connection is a skimmer device or a connection attempting to compromise information. For example, transaction obstruction program 101 determines device A is wirelessly connected to a network and five other devices and has been connected for 5 hours. In this example, transaction obstruction program 101 determines a high priority level based on the duration and number of wireless connections and stores this high priority level assigned to device A in communication database 132. In an embodiment, transaction obstruction program 101 stores a list of previously identified unknown connections in communication database 132. In an embodiment, transaction obstruction program 101 accesses communication database 132 to determine if a device has previously been identified as having a high priority level.

In an embodiment, communication database 132 includes user input including information on customized information on transactions, connections, and other connection information. For example, user input includes the device IDs of desired device connections, the type of business the network is used for, average length of time of connections, threshold of connections to a network, average duration of connections, previous connections, and previously identified malicious connections. For example, if a user input includes information that the network location is a drive through restaurant, transaction obstruction program 101 stores this information in communication database 132. In an embodiment, transaction obstruction program 101 monitors a network for connections and wireless connections, determines the average length of time of connections, average duration of connections, and transaction information and stores this information in communication database 132.

In an embodiment, communication rules 134 includes information or rules associated with a dynamic set of policies for determining an abnormal connection based on information included in communication database 132 and external environment factors. In an embodiment, external environment factors can include the weather, other nearby users, or any other factor which could affect the outcome or actions of determining an abnormal connection. Such as, a user or a device may stay in a location and connected to a network for a longer or shorter period of time based on the weather or temperature. For example, when it is sunny outside it is more likely a user and their devices at an outdoor establishment stay connected to a network longer than on a rainy day. In an embodiment, communication rules 134 includes information describing different decision-making actions transaction obstruction program 101 should perform depending on the particular length of the connection, number of other connections, device information, transaction information, previous connections, connection history, previously identified malicious devices, number of failed attempts to connect to the network, previously identified priority levels, information included in communication database 132, and the surrounding environment in which the transaction is requested. For example, a device wirelessly connected to over five other wireless devices is more likely to be a skimmer device than a device wirelessly connected to one other wireless device. In an embodiment, communication rules 134 are selected based on the determined priority level associated with the risk or confidence level that a connection is a malicious connection. For example, if transaction obstruction program 101 determines a priority level of 6 out of 10 for a connection, transaction obstruction program 101 selects the rule from communication rules 134 for rules with a priority level of 6. In an embodiment, communication rules 134 are selected based on the type of transaction, transaction amount above a predetermined threshold, or industry. In another example, transaction obstruction program 101 receives user input the network location is a drive through restaurant. Here, transaction obstruction program 101 selects a rule from communication rules 134 for a drive through restaurant. In another example, if transaction obstruction program 101 receives a transaction request for $5000, where the predetermined transaction threshold is $500, transaction obstruction program 101 selects the rule from communication rules 134 for rules for transactions exceeding the predetermined transaction threshold. In another example, transaction obstruction program 101 determines a device has previously been connected and identified as a malicious device. Here, transaction obstruction program 101 selects a rule from communication rules 134 for rules for previously identified malicious devices. In this example, the selected rule indicates to automatically block the communication to and from the previously identified device.

In an embodiment, transaction device 150 is any device where a transaction, withdrawal, or user can gain access to a resource. For example, transaction device 150 can include an ATM, cardless ATM, a bank, a store, a stationary terminal, a point of sale terminal, an online or mobile banking application, or a mobile device, such as user device 110. In another example, transaction device 150 is a cash register at a store used to complete a transaction exchanging money for food.

In an embodiment, transaction obstruction program 101 monitors the area within a predetermined radius of a transaction device for wireless connections and wireless connection attempts to a particular network. In an embodiment, transaction obstruction program 101 identifies a skimmer or outlier connection based, at least in part, on the users input, threshold of connections and/or connection attempts, duration of connections, number of connections or connection attempts, and other variables or external factors. In an embodiment, transaction obstruction program 101 identifies a skimmer based on detected patterns or lack of detected patterns. In an embodiment, transaction obstruction program 101 identifies outliers to a detected pattern. For example, transaction obstruction program 101 identifies a detected pattern that many devices connect to the network and no device outside of the predetermined allowable devices connects to the network for more than 5 minutes. Here, transaction obstruction program 101 identifies a new connection lasting over 5 minutes as an outlier to the determined pattern. In an embodiment, transaction obstruction program 101 identifies patterns based on a certain number of devices or a particular device typically connected to the network at certain times of the day or certain days of the week. In an embodiment, transaction obstruction program 101 determines a pattern is disrupted when the particular type of devices or number of devices for a certain time changes. For example, if transaction obstruction program 101 identifies a pattern that device A and device B are connected from around 9 am-5 pm almost every Monday-Friday, transaction obstruction program 101 determines a pattern is disrupted when device A or device B are connected at 10 pm on a Saturday.

In an embodiment, transaction obstruction program 101 determines an outlier wireless connection within the network environment based, at least in part, on the determined wireless connection pattern associated with the network environment. In an embodiment, transaction obstruction program 101 executes an additional obstruction rule based, at least in part, on the determined outlier wireless connection within the network environment.

In an embodiment, transaction obstruction program 101 receives user input from a user. In an embodiment, the user input includes information on the network environment. In an embodiment, the user input includes information on the industry or business type, a threshold of connections to a network, an average number of connections, the average duration of connections. In an embodiment, transaction obstruction program 101 determines a wireless connection pattern based, at least in part, on the user input. In an embodiment, transaction obstruction program 101 receives or determines particular metrics, thresholds, etc. as to when/how to detect potential skimmer devices. In an embodiment, transaction obstruction program 101 monitors a network to determine length of time of connections, duration of connections, attempted connections, and transaction information and stores this information in communication database 132. In an embodiment, transaction obstruction program 101 determines the average length of time of connections and average duration of connections. In an embodiment, transaction obstruction program 101 receives user input indicating allowable connections. For example, transaction obstruction program 101 receives user input indicating transaction devices A, B, and C are allowable connections.

In an embodiment, transaction obstruction program 101 determines a communication or connection to a network. In an embodiment, transaction obstruction program 101 determines the connection duration, number of simultaneous connections to the network, number of attempted connections to the network, and information requested in the communication. For example, an attempted connection can include when a device tries to connect to a network but is unsuccessful. In an embodiment, transaction obstruction program 101 determines a priority level of a connection based, at least in part, on the user input or determined average length of time of connections and average duration of connections, the connection duration, number of connections to the network, number of attempted connections to the network, and information requested in the communication. For example, if transaction obstruction program 101 determines the average connection length is five minutes and device A has been wirelessly connected to the network for twenty minutes, transaction obstruction program 101 determines a high priority level. In an embodiment, transaction obstruction program 101 increases the priority level if the device is connected to a network above a predetermined amount of time. For example, if the predetermined amount of time is 3 minutes, transaction obstruction program 101 assigns a priority level of 1 when the device is connected to the network for one minute. After the device is connected to the network for 15 minutes, transaction obstruction program 101 increases the priority level to 3.

In an embodiment, transaction obstruction program 101 determines a priority level based on the number of devices connected to a transaction device. In an embodiment, transaction obstruction program 101 increases the priority level based on an increased number of devices connected to a transaction device. For example, transaction obstruction program 101 receives user input the business is a gas station and ten gas pump transaction devices should be connected to the network. In this example, transaction obstruction program 101 receives information eleven devices are connected to the network. In this example, transaction obstruction program 101 determines a high priority level since an additional connection is connected to the network. In the same example, if transaction obstruction program 101 receives information that nine devices are connected to the network and a tenth device is connected, a low priority level is assigned to the new connection.

In an embodiment, the priority level is based, at least in part on one or more of an average length of time of the one or more wireless communications, average duration of the one or more wireless communications, network connection duration, number of simultaneous connections to the network, number of attempted communications to the network, number of failed attempts to connect to the network, and information requested in the connection. In an embodiment, transaction obstruction program 101 increases the priority level based on an increased number of failed attempts to connect to the network. For example, a device with three failed attempts at connecting to the network will have a higher priority level than a device with one failed attempt at connecting to the network.

In an embodiment, transaction obstruction program 101 determines one or more nodes associated with the unknown connection. In an embodiment, transaction obstruction program 101 requests additional information from one or more nodes associated with an unknown connection. In an embodiment, transaction obstruction program 101 determines communication details between nodes. In an embodiment, the communication details between nodes include, but are not limited to, number of devices connected, device IDs of connected devices, duration of device connections, location of connected devices, information requested in the communication, and other device connection information.

In an embodiment, transaction obstruction program 101 selects a rule based, at least in part, on the unknown connection or communication. For example, if transaction obstruction program 101 determines the unknown connection configurations are configured to connect to any wireless device, transaction obstruction program 101 selects a rule for configuration settings allowing connections to any wireless device. In an embodiment, the rule selected specifies one or more particular actions for transaction obstruction program 101 to take. For example, an action can include alerting or notifying a user or user device, blocking the transaction, executing a MITM attack, or executing a DDOS attack.

In an embodiment, transaction obstruction program 101 executes an obstruction action associated with a particular rule. For example, if the selected obstruction rule specifies to send a message to a user about the unknown connection or communication, transaction obstruction program 101 sends a message to a user about the unknown connection. For example, if a wireless connection at a gas station is deemed high priority, transaction obstruction program 101 selects a rule for a high priority wireless connection at a gas station for notifying the gas attendee and then notifies the gas attendee of the high priority wireless connection by sending a digital message. In another example, transaction obstruction program 101 selects an obstruction rule specifying to stop any further transaction requests from or to the unknown wireless connection. Here, transaction obstruction program 101 stops any further transaction requests from or to the unknown wireless connection. In another example, transaction obstruction program 101 selects a rule specifying to turn on or record from a security camera. Here, transaction obstruction program 101 either turns on or begins recording from a security camera.

In an embodiment, transaction obstruction program 101 determines information on the unknown connection such as its data transfer, data history, and connection history and stores this information in communication database 132. In an embodiment, transaction obstruction program 101 adds the determined unknown connection and justification to a list in communication database 132. In an embodiment, transaction obstruction program 101 accesses the list in communication database 132 and obstructs the connection for a device on the list of connections in communication database 132.

In an embodiment, the communication is conducted via a wireless or wired communication. In wired communication environments it will be in a separate medium to handle scenarios where a pineapple device is used to gather information around the environment. Making it difficult to pretend to be part of the system or be able to push out inaccurate information, such as a false device ID or name.

In an example, a main device is able to connect with seven sub-devices or subscribers. In this example, transaction obstruction program 101 monitors the communication and sub-devices and determines an unknown connection to the main device based on the users input of the seven sub-devices device IDs. In this example, transaction obstruction program 101 sends a request filling up the connection limit of the indicated node.

In an example, the user input indicated only allowing a single connection per device. Such as a user using a debit card to pay for gas at a gas station while wearing wireless headphones. Here in this example, the user is able to wirelessly pay for gas via their debit card without interfering with the wireless headphones.

In an embodiment, transaction obstruction program 101 detects and selectively blocks wireless skimmer devices. In an embodiment, a wireless skimmer device connects to a network via Wi-Fi, Bluetooth, Near Field Communication (NFC) or any other generally known wireless technologies. In an embodiment, transaction obstruction program 101 monitors wireless communications with a predetermined range of a transaction device. In an embodiment, in response to actively monitoring wireless communications in a predetermined area, transaction obstruction program 101 determines whether a communication is associated with a potential attacker using predetermined criteria including a set of configurable rules. In response to a determination the communication is associated with a potential attacker, transaction obstruction program 101 identifies an associated device is malicious using second predetermined criteria including attempting to identify a node which actively connects to other nodes, a number of successful connections in a given time exceeds a first predetermined threshold, a length of the communication exceeds a second predetermined threshold. In response to a determination associated device is malicious, transaction obstruction program 101 executes at least one action in a set of predetermined actions to stop the associated device from communicating with other devices by interfering the communication. In response to a determination to gather more information about a source device associated with the communication, transaction obstruction program 101 executes at least one action in a set of predetermined actions to imitate a destination device to perform at least one action of gathering more information, deceiving the destination device, and connecting to the destination device via multiple virtual devices in a denial-of-service attack. In an embodiment, transaction obstruction program 101 alerts a predetermined user or user device of malicious device, providing details about action taken and information associated with determining justification of the action to update historical information in a repository.

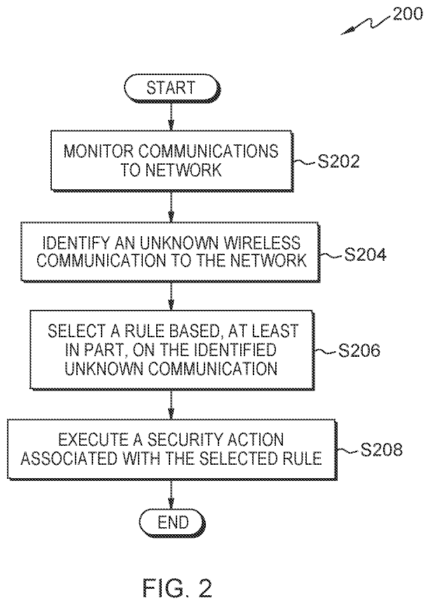

FIG. 2 is a flow chart diagram depicting operational steps for transaction obstruction program 101, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, transaction obstruction program 101 monitors communications on a network. At step S204, transaction obstruction program 101 identifies an unknown wireless communication to the network. At step S206, transaction obstruction program 101 selects a rule based, at least in part, on the identified unknown communication. At step S208, transaction obstruction program 101 executes a security action associated with the selected rule.

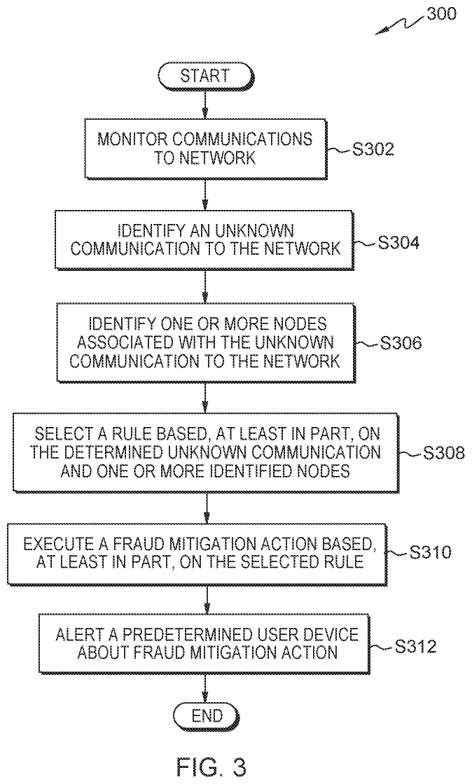

FIG. 3 is a flow chart diagram depicting operational steps for transaction obstruction program 101, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step 302, transaction obstruction program 101 monitors communication to a network. At step 304, transaction obstruction program 101 identifies an unknown communication to the network. At step 306, transaction obstruction program 101 identifies one or more nodes associated with the unknown communication to the network. At step 308, transaction obstruction program 101 selects a rule based, at least in part, on the determined unknown communication and the one or more identified nodes. At step 310, transaction obstruction program 101 executes a fraud mitigation action based, at least in part, on the selected rule. In an embodiment, transaction obstruction program 101 the fraud mitigation action is the execution of a denial-of-service attack. In an embodiment, the fraud mitigation action is disconnecting a device associated with the unknown connection from the network. At step 312, transaction obstruction program 101 alerts a predetermined user device about fraud mitigation action. For example, if a predetermined user device is a computer within the business, transaction obstruction program 101 alerts the computer within the business of the denial-of-service attack. For example, transaction obstruction program 101 sends a digital message to the computer.

FIG. 4 is a block diagram depicting components of a computing device, generally designated 400, suitable for transaction obstruction program 101 in accordance with at least one embodiment of the invention. Computing device 400 includes one or more processor(s) 404 (including one or more computer processors), communications fabric 402, memory 406 including, RAM 416 and cache 418, persistent storage 408, which further includes transaction obstruction program 101, communications unit 412, I/O interface(s) 414, display 422, and external device(s) 420. It should be appreciated that FIG. 4 provides only an illustration of one embodiment and does not imply any limitations with regard to the environments in which different embodiments may be implemented. Many modifications to the depicted environment may be made.

As depicted, computing device 400 operates over communications fabric 402, which provides communications between computer processor(s) 404, memory 406, persistent storage 408, communications unit 412, and input/output (I/O) interface(s) 414. Communications fabric 402 can be implemented with any architecture suitable for passing data or control information between processor(s) 404 (e.g., microprocessors, communications processors, and network processors), memory 406, external device(s) 420, and any other hardware components within a system. For example, communications fabric 402 can be implemented with one or more buses.

Memory 406 and persistent storage 408 are computer readable storage media. In the depicted embodiment, memory 406 includes random-access memory (RAM) 416 and cache 418. In general, memory 406 can include any suitable volatile or non-volatile computer readable storage media.

Program instructions for transaction obstruction program 101 can be stored in persistent storage 408, or more generally, any computer readable storage media, for execution by one or more of the respective computer processor(s) 404 via one or more memories of memory 406. Persistent storage 408 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 can include one or more network interface cards. Communications unit 412 may provide communications through the use of either or both physical and wireless communications links. In the context of some embodiments of the present invention, the source of the various input data may be physically remote to computing device 400 such that the input data may be received, and the output similarly transmitted via communications unit 412.

I/O interface(s) 414 allows for input and output of data with other devices that may operate in conjunction with computing device 400. For example, I/O interface(s) 414 may provide a connection to external device(s) 420, which may be as a keyboard, keypad, a touch screen, or other suitable input devices. External device(s) 420 can also include portable computer readable storage media, for example thumb drives, portable optical or magnetic disks, and memory cards. Software and data used to practice embodiments of the present invention can be stored on such portable computer readable storage media and may be loaded onto persistent storage 408 via I/O interface(s) 414. I/O interface(s) 414 also can similarly connect to display 422. Display 422 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

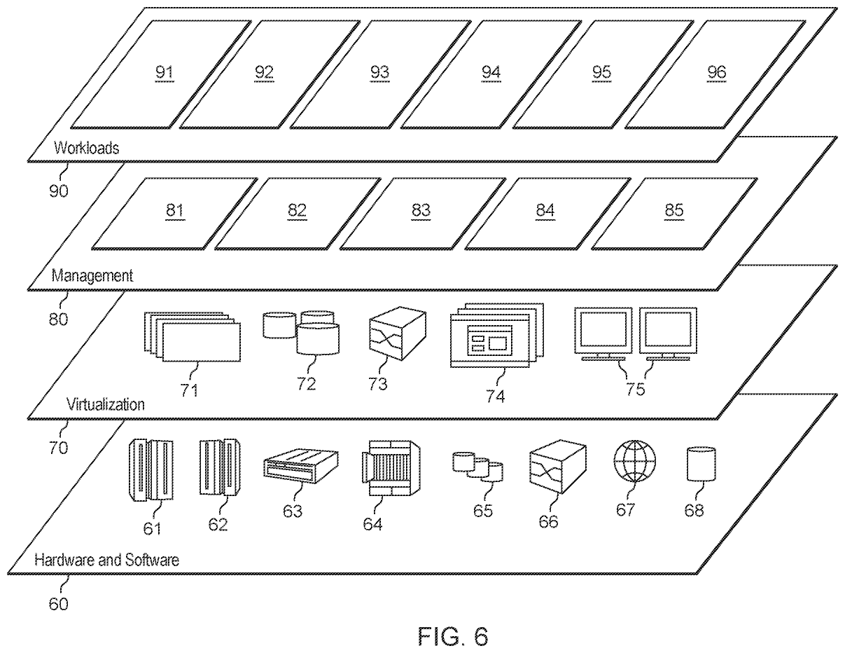

FIG. 6 is block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction obstruction 96.

What is claimed is:

1. A computer-implemented method for detecting and obstructing skimmer devices, the computer-implemented method comprising:
monitoring wireless communications within a network environment;
identifying information associated with one or more wireless communications within the network environment transmitted by an unknown wireless device;
selecting an obstruction rule based, at least in part, on the information associated with the one or more wireless communications transmitted by the unknown wireless device; and
executing an obstruction action corresponding to the selected obstruction rule.

2. The computer-implemented method of claim 1, wherein selecting the obstruction rule is further based, at least in part, on a determined priority level associated with the one or more wireless communications transmitted by the unknown wireless device.

3. The computer-implemented method of claim 2, wherein the priority level is based, at least in part on: an average length of time of the one or more wireless communications, average duration of the one or more wireless communications, network connection duration, number of simultaneous connections to the network, number of attempted communications to the network, number of failed attempts to connect to the network, and information requested in the connection.

4. The computer-implemented method of claim 1, further comprising:
determining a wireless connection pattern associated with the network environment;
determining an outlier wireless connection within the network environment based, at least in part, on the determined wireless connection pattern associated with the network environment; and
executing an additional obstruction rule based, at least in part, on the determined outlier wireless connection within the network environment.

5. The computer-implemented method of claim 4, wherein the wireless connection pattern associated with the network environment is determined based, at least in part, on a number of devices connected to the network environment, device IDs of the connected devices within the network environment, duration of device connections to the network environment, location of connected devices to the network environment, and time of day of the connections.

6. The computer-implemented method of claim 1, wherein executing an obstruction action corresponding to the selected obstruction rule further comprises:
imitating a destination device to perform an action selected from the group consisting of gathering more information, deceiving the destination device, and connecting to the destination device via multiple virtual devices in a denial-of-service attack.

7. The computer-implemented method of claim 1, further comprising:
determining that the unknown wireless device is a previously identified malicious device; and
automatically blocking communications to and from the unknown wireless device.

8. A computer program product for detecting and obstructing skimmer devices, the computer program product comprising one or more computer readable storage media and program instructions stored on the one or more computer readable storage media, the program instructions including instructions to:
monitor wireless communications within a network environment;
identify information associated with one or more wireless communications within the network environment transmitted by an unknown wireless device;
select an obstruction rule based, at least in part, on the information associated with the one or more wireless communications transmitted by the unknown wireless device; and
execute an obstruction action corresponding to the selected obstruction rule.

9. The computer program product of claim 8, wherein the instructions to select the obstruction rule is further based, at least in part, on a determined priority level associated with the one or more wireless communications transmitted by the unknown wireless device.

10. The computer program product of claim 9, wherein the priority level is based, at least in part on: an average length of time of the one or more wireless communications, average duration of the one or more wireless communications, network connection duration, number of simultaneous connections to the network, number of attempted communications to the network, number of failed attempts to connect to the network, and information requested in the connection.

11. The computer program product of claim 8, further comprising instructions to:
determine a wireless connection pattern associated with the network environment;
determine an outlier wireless connection within the network environment based, at least in part, on the determined wireless connection pattern associated with the network environment; and
execute an additional obstruction rule based, at least in part, on the determined outlier wireless connection within the network environment.

12. The computer program product of claim 11, wherein the wireless connection pattern associated with the network environment is determined based, at least in part, on a number of devices connected to the network environment, device IDs of the connected devices within the network environment, duration of device connections to the network environment, location of connected devices to the network environment, and time of day of the connections.

13. The computer program product of claim 8, wherein the instructions to execute an obstruction action corresponding to the selected obstruction rule further comprise instructions to:
imitate a destination device to perform an action selected from the group consisting of gathering more information, deceiving the destination device, and connecting to the destination device via multiple virtual devices in a denial-of-service attack.

14. The computer program product of claim 8, further comprising instructions to:
determine that the unknown wireless device is a previously identified malicious device; and
automatically block communications to and from the unknown wireless device.

15. A computer system for detecting and obstructing skimmer devices, comprising:
one or more computer processors;
one or more computer readable storage media;
computer program instructions;
the computer program instructions being stored on the one or more computer readable storage media for execution by the one or more computer processors; and
the computer program instructions including instructions to:
monitor wireless communications within a network environment;
identify information associated with one or more wireless communications within the network environment transmitted by an unknown wireless device;
select an obstruction rule based, at least in part, on the information associated with the one or more wireless communications transmitted by the unknown wireless device; and
execute an obstruction action corresponding to the selected obstruction rule.

16. The computer system of claim 15, wherein the instructions to select the obstruction rule is further based, at least in part, on a determined priority level associated with the one or more wireless communications transmitted by the unknown wireless device.

17. The computer system of claim 16, wherein the priority level is based, at least in part on: an average length of time of the one or more wireless communications, average duration of the one or more wireless communications, network connection duration, number of simultaneous connections to the network, number of attempted communications to the network, number of failed attempts to connect to the network, and information requested in the connection.

18. The computer system of claim 15, further comprising instructions to:
determine a wireless connection pattern associated with the network environment;
determine an outlier wireless connection within the network environment based, at least in part, on the determined wireless connection pattern associated with the network environment; and
execute an additional obstruction rule based, at least in part, on the determined outlier wireless connection within the network environment.

19. The computer system of claim 18, wherein the wireless connection pattern associated with the network environment is determined based, at least in part, on a number of devices connected to the network environment, device IDs of the connected devices within the network environment, duration of device connections to the network environment, location of connected devices to the network environment, and time of day of the connections.

20. The computer system of claim 15, wherein the instructions to execute an obstruction action corresponding to the selected obstruction rule further comprise instructions to:
imitate a destination device to perform an action selected from the group consisting of gathering more information, deceiving the destination device, and connecting to the destination device via multiple virtual devices in a denial-of-service attack.
